(19) United States
(12) Patent Application Publication
(10) Pub. No.: US 2005/0282524 A1
(43) Pub. Date: Dec. 22, 2005

(54) Digital radio data system information data messaging

(75) Inventor: Jackson Wang, Toronto (CA)

Correspondence Address: JONES DAY, 222 EAST 41ST ST, NEW YORK, NY, 10017, US

(73) Assignee: e-Radio USA, LLC

(21) Appl. No.: 10/869,261

(22) Filed: Jun. 16, 2004

(51) Int. Cl. H04M 3/16

(52) U.S. Cl. 455/412.1; 455/466

(57) ABSTRACT

A data messaging system is provided utilizing In-Band On-Channel (IBOC) Digital Audio Broadcasting systems enabled to transmit and receive location specific traffic, weather, emergency alert, and/or other third party application information. An extensible markup language (XML) is used to enable the hardware with an “information grid” to provide processing capabilities of HD IBOC capable FM radios. Utilization of XML technology will allow display of various applications that are language independent, particularly, real time data messaging of traffic messages generated as XML output.

### RELATED APPLICATIONS

There are no previously filed, nor currently any co-pending applications, anywhere in the world.

### BACKGROUND OF THE INVENTION

1. Field of the Invention

The present invention relates generally to radio data system and, more particularly, to a digital radio based text messaging system using an In-Band On-Channel (IBOC) Digital Audio Broadcasting systems approach to deliver new digital services simultaneously with audio for receiving location specific traffic or weather information.

2. Description of the Related Art

In-Band On-Channel (IBOC) Digital Audio Broadcasting systems bring the benefits of digital audio broadcasting to today's radio while preventing interference to the “host” analog station and stations on adjacent channels. Referred to as high definition radio (HD Radio), this technology delivers new digital services simultaneously with the existing analog broadcast. These new digital signals are broadcast as “sideband” transmissions bracketing the top and bottom of the current “host” analog signal in order to make optimal usage of the current spectrum allocations. With more than half of stations currently facing interference from adjacent stations, this approach delivers redundant information on both sides of the current channel location in order to ensure optimal performance in all listening environments.

IBOC technology further combats interference through a unique First Adjacent Canceller (FAC) technology. FAC automatically differentiates between the digital sideband transmission and other analog signals that might be closely adjacent to the channel in order to suppress the interfering station.

IBOC technology overcomes multipath interference and sources of noise through the use of coding and power combining techniques. This approach to error correction utilizes digital processors and powerful algorithms to constantly compare the quality of the two digital sideband transmissions, combining them to deliver additional power gain whenever possible and when not possible seamlessly switching to the more powerful of the two.

In much the same way that a portable CD player digitally stores a short passage of music in order to overcome any momentary interruptions, the interleaver approach incorporated into IBOC technology further enhances performances. By “caching” or storing the broadcast into short-term memory, the interleaver allows for the uninterrupted transition between analog and digital signal within the same channel in order to avoid the drop off that might occur due to a bridge or other obstruction. In order to deliver instantaneous tuning, the interleaver also seamlessly enables the initial selection of the analog signal and subsequent transition to the digital signal once properly cached. Compression of audio data will increase transmission without losing sound quality.

By employing the above techniques incorporating multiple digital signal techniques, such as redundant sidebands, blend, first adjacent cancellation, and code and power sharing, IBOC technology is designed to capture a superior robust signal within a station's coverage area in order to ensure delivery of the benefits of HD Radio technology.

IBOC provides a unique opportunity for broadcasters and consumers to transition from analog to digital broadcasting without service interruption while maintaining the current dial positions of existing radio stations. Consumers who purchase digital radios will receive their favorite AM and FM stations with superior digital quality, free from the static, hiss, pops and fades associated with analog radio reception. In addition to offering digital audio quality and crystal clear reception, IBOC offers the broadcaster the lowest entry cost into the wireless data industry. Through careful attention to the equipment decisions made today, broadcasters may significantly reduce the cost of conversion.

In the prior art, travel information with RDS is possible using the Travel Program (TP) and Travel Announcement (TA) flags. Information is broadcast for motorists, identified in parallel with the ARI system with the corresponding RDS features TP/TA. But ARI is being replaced on a European scale, so it will cease after the year 2005. A more recent development of RDS is the digitally coded Traffic Message Channel (TMC) which is now planned to be introduced all over Europe, within projects funded by the European Union. However, present RDS radios are not yet suitable for RDS-TMC for use in the United States.

Consequently, a need has been felt for providing a method of providing real time traffic information via text messaging utilizing HD radio based real time text messaging system using In-Band On-Channel (IBOC) Digital Audio Broadcasting systems.

### SUMMARY OF THE INVENTION

It is therefore an object of the present invention to provide an improved radio based data messaging system.

It is a feature of the present invention to provide real time traffic message control delivered using In-Band On-Channel (IBOC) Digital Audio Broadcasting systems.

Briefly described according to one embodiment of the present invention, a data messaging system is provided utilizing In-Band On-Channel (IBOC) Digital Audio Broadcasting systems enabled to transmit and receive location specific traffic, weather, emergency alert, and/or other third party application information. An extensible markup language (XML) is used to enable an “information grid” to provide processing capabilities of HD IBOC capable FM radios. Utilization of XML technology will allow display of various applications that are language independent, particularly, real time data messaging of traffic messages generated as XML output.

In accordance with a preferred embodiment, a radio based data messaging system can be created using HD IBOC receivers for receiving location specific information.

An advantage of the present invention is that it can be adapted for use with a variety of location specific information, such as weather, traffic, emergency alert, or third party application information or the like, without significant hardware modification.

Another advantage of the present invention is that it can develop eventual text messages from any existing third party information stream.

Yet another advantage of the present invention is that it utilizes XML technology will allow text display of various applications that are language independent.

Yet another advantage of the present invention is that it can be used to enable a new information transmission grid.

Yet another advantage of the present invention is that it is capable of being nationally coordinated, but locally distributed.

Further, a preferred embodiment of the present invention has the capability of being the foundation for a more specific data messaging system implemented using a vehicle located FM receiver as the text display mechanism.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a block diagram of a HD Radio based data messaging system using IBOC receivers for receiving location specific information; and

FIG. 2 is a functional schematic diagram thereof.

### DESCRIPTION OF THE PREFERRED EMBODIMENTS

In order to describe the complete relationship of the invention, it is essential that some description be given to the manner and practice of functional utility and description of radio broadcast data system (RBDS). The standards for this system are best described in the “United States RBDS Standard” by the National Radio Systems Committee of the National Association of Broadcasters, as described in USPTO form PTO-1440 and incorporated by reference herein as if fully rewritten.

The best mode for carrying out the invention is presented in terms of its preferred embodiment, herein depicted within the Figures.

1. Detailed Description of the Figures

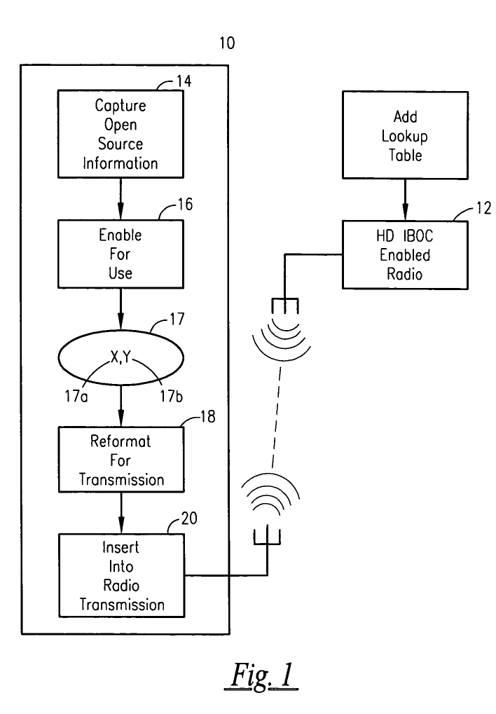

Referring now to FIG. 1, a data messaging system 10 is generally described anticipated as utilizing an In-Band On-Channel (IBOC) Digital Audio Broadcasting system that utilizes existing HD Radio receiver hardware 12. Although such a receiver 12 is anticipated as already being enabled to receive digital “sideband” transmission signals simultaneously with the existing analog broadcast, the receiver 12 must be modified to give meaning to any specific received data. This modification is described in greater detail below. The origin of the data that functions as the initial source for the eventual text message is anticipated as being a third party information stream 14. Data standards currently exist for the characterization and providing of traffic information. However, it is anticipated that other similar data streams can be substituted analogously, such as weather data, emergency notification information such as “amber alert” information, or other third party data applications or the like. In any event, the raw or previously processed information from the third party information stream 14 is then enable for use 16 by converting it from generic content to a series of binary data packets 17 each consisting of a location code 17a tied to an event code 17b. The location code 17a would be fixed to a specific geographic reference, and would be linked to the event code 17b corresponding to a reported event at that specific location. The event code 17b would correspond a specific reportable event of interest occurring a that specific location.

By way of example, but not as a limitation, in a traffic reporting scenario a location code representing the interchange of Interstate 95 and Interstate 295 would be given a fixed location code, with reportable events corresponding to real-time activity at that location being selected from a pre-determined table incorporating a comprehensive list of reportable events. These can include “lane closures”, “accidents”, “disabled vehicles” or other type of obstructions, as well as link impedance determinations such as “traffic at 30% capacity” or “traffic moving at 45 mph” type of standard Traffic and Traveller Information (TTI). Once the data is enabled for use 16 into linked event codes and location codes, it is reformatted to be accommodated by the transport infrastructure 18. Next, the reformatted data is inserted into the radio transmission stream 20 for transmission within the HD Radio envelop, or otherwise adapted for the IBOC or other particular transportation infrastructure.

Finally to the general description of the present invention, the receiver 12 that is enabled to receive data transmitted is modified to give meaning to the received data. This is accomplished by adding within its memory a lookup table storing the pre-determined comprehensive list of reportable event codes as well as adding within its memory a lookup table storing a pre-determined required list of location codes. It is assumed that this can be accomplished by use of CD, DVD, RAM, ROM, Flash or any other conventional method for providing memory storage retrievable by the radio's microprocessor.

By encoding these lookup tables, the radio will be able to interpret and display meaningful data transmissions.

2. Operation of the Preferred Embodiment

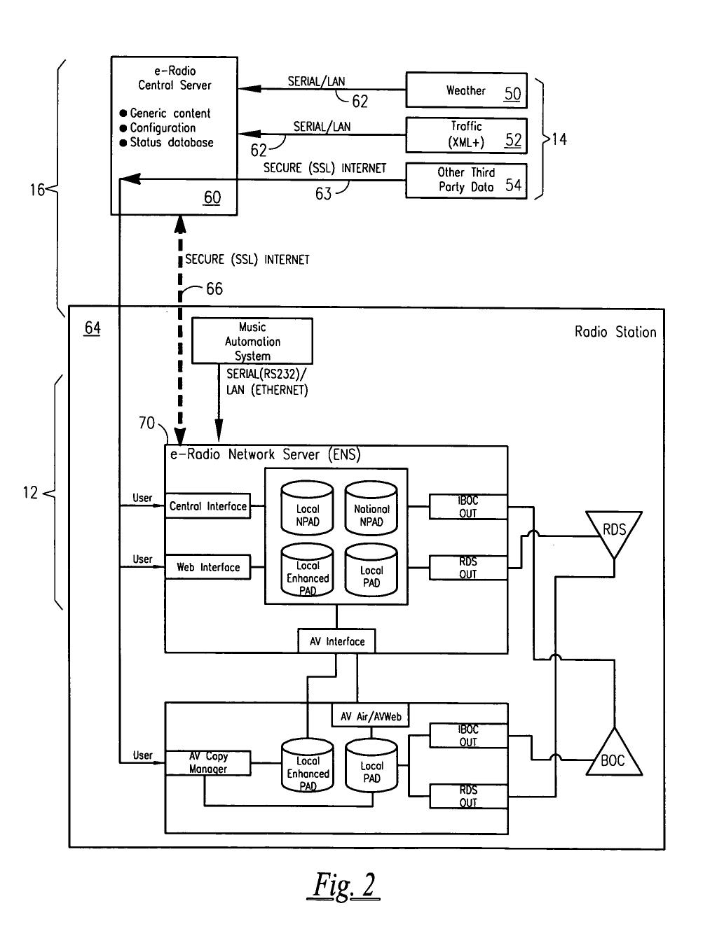

In accordance with a preferred embodiment of the present invention, as shown in FIG. 2, a particular application of the present system is shown for purposes of describing a preferred embodiment of the present invention. As is shown, the present system can be used for a third party information stream such a weather 50, traffic 52, or other specialized third party, or proprietary data specialized for a particular purpose 54. It is anticipated that current data standards that utilize an extensible markup language (XML) currently exist, and would therefore be adopted, thereby allowing the present invention to become immediately deployable, but also to allow for future changes or additions, such as changes in event terminology, as well as migration of existing terminology to various language translations. In any event, the data source 50 is communicated to a central server 60 via any traditional communication means 62, herein shown as a standard Internet™ or encrypted Internet™ connection 63. The central server 60 receives the generic content and enables it for use 16 and forwards the content to a distributed network server 64, after performing three general functions:
a. Validating of the generic information. The information is checked for quality and consistency. Further, not all the data that is received will necessarily be broadcasted, so the central server 60 will remove unqualified data or events
b. Reformatting for Broadcast. Not all the data that is received will necessarily be broadcasted, so the central server 60 will remove unqualified data or events. Further, the data will be enabled for use into linked event codes and location codes.
c. Filtering for Specific Distributed Network Server. Data for all locations will not need to be transmitted to every distributed network server 64. Therefore, the central server 60 will filter the entire pool of data and sort by relevant Distributed network server general location.
   The validated, formatted and filtered data 66 is transmitted to one of potentially many distributed network servers 64, each of which would reformat the data to be accommodated by the transport infrastructure 18, and insert the data into the radio transmission stream 20 for transmission within HD radio envelop. This may be done at the local radio station level through the use of an In-Band On-Channel (IBOC) Digital Audio Broadcasting system converter 70, or equivalent.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. By way of example, and not as a limitation, it is anticipated that the present method can be adapted or modified for receiving alternate text data by utilizing an extensible markup language (XML) to enable the existing hardware capabilities of high definition digital capable radios. Utilization of XML technology will allow display of various applications that are language independent, particularly, real time data messaging of traffic messages generated as XML output.

Therefore, the scope of the invention is to be limited only by the following claims.

1. A method for enabling a data messaging system using In-Band On-Channel (IBOC) Digital Audio Broadcasting systems for receiving location specific information, said method comprising the steps:
a. Enable an information stream for use by converting it from generic content to a series of binary data packets each consisting of a location code and an event code;
b. Linking each event code to a specific location code; and
c. Reformatting said enabled information to be accommodated by the transport infrastructure.

2. The method of claim 1, further comprising the steps:
a. Inserting said enabled information into the radio transmission stream for transmission within the HD radio envelop.

3. The method of claim 1, wherein in linking each event code to a specific location, said location code would be fixed to a specific geographic reference, and would be linked to said event code.

4. The method of claim 3, wherein said event code would correspond a specific reportable event of interest occurring at a specific location.

5. The method of claim 4, wherein said event code is selected from a group comprising: travel and traffic information; weather information; emergency notification information including amber alert information; and other third party data applications.

6. The method of claim 2, further comprising the step:
formatting a compatible radio to give meaning to the received data enabled information.

7. The method of claim 6, wherein said modification comprises:
adding within said radio's memory a lookup table storing the pre-determined comprehensive list of reportable event codes as well as adding within its memory a lookup table storing a pre-determined required list of location codes,
wherein by encoding these lookup tables, the radio will be able to interpret and display meaningful text transmissions.

8. An information grid comprising:
a macro-coordinated information stream;
communication means for communicating said information a central server;
at least one central server for receiving content and enabling it for use and forwarding the content to at least one distributed network server;
at least one distributed network server for reformatting the data to be accommodated by a transport infrastructure; and
at least one In-Band On-Channel (IBOC) Digital Audio Broadcasting systems capable radio receiver.

9. The information grid of claim 8, wherein said communication means is selected from the group comprising: a standard Internet™ connection; and, encrypted Internet™ connection.

10. The information grid of claim 8, wherein said central server further validates said information.

11. The information grid of claim 8, wherein said central server further checks said information for quality and consistency.

12. The information grid of claim 8, wherein said central server further filters said information, thereby removing any unqualified data or events.

13. The information grid of claim 8, wherein said central server further reformats said information for broadcast by enabling for use by linking event codes and location codes.

14. The information grid of claim 12, where said the central server will filter the entire pool of data and sort by relevant distributed network server general location.

15. The information grid of claim 8, wherein:
said transmission infrastructure comprises a radio transmission means; and
said distributed network server inserts the data into the radio transmission stream for transmission within the HD radio envelop.

16. The information grid of claim 15, wherein said distributed network server inserts said data into said radio transmission stream via an In-Band On-Channel (IBOC) Digital Audio Broadcasting systems encoder.

17. The information grid of claim 8, wherein said radio receiver is modified by adding within said radio's memory a lookup table storing the pre-determined comprehensive list of reportable event codes as well as adding within its memory a lookup table storing a pre-determined required list of location codes.
